(19) United States
(12) Patent Application Publication
(10) Pub. No.: US 2023/0122895 A1
(43) Pub. Date: Apr. 20, 2023

(54) STAND FOR COMPACT DEVICE

(71) Applicant: Custom Accessories Inc., Richmond, IL (US)

(72) Inventors: Vincent A. Alesi, Richmond, IL (US); Anthony Salvatore Ferenzi, Richmond, IL (US)

(73) Assignee: Custom Accessories Inc., Richmond, IL (US)

(21) Appl. No.: 17/506,260

(22) Filed: Oct. 20, 2021

(51) Int. Cl. F16M 11/04; F16M 11/10

(52) U.S. Cl. CPC F16M 11/041; F16M 11/10; F16M 2200/08

(57) ABSTRACT

A stand for a compact utility device includes a base and a holder assembly. The holder assembly includes a housing defining an interior space. The housing is attached to and is supported by the base. A first arm and a second arm are moveably disposed in and extend from the interior space of the housing. The first arm and the second arm extend from opposite sides of the housing and the first arm and the second arm are cooperatively configured to hold a compact utility device. An adjusting mechanism is disposed in the interior space of the housing and is operably connected to the first arm and the second arm and is configured to synchronize movement of the first arm and the second arm when one of the first arm and second arm are moved outwardly or inwardly.

### BACKGROUND OF THE INVENTION

Computing/communication and similar electronic devices have become ubiquitous, more compact, and more portable. Tablets and laptop computers have largely replaced desktop computers. Cell phones, despite their small size, are capable of performing many of the tasks that support the complex and busy lifestyle of the present day. For at least this reason, a significant number of individuals are seldom separated from their cell phones or similar devices, including while driving or multitasking in various settings. Compact computing devices also include electronic devices such as reading tablets, which have a selected, specific use such as, for example, the display of text.

The number of uses for small personal electronic devices such as cell phones in particular, has expanded recently to include the ability to conduct remote meetings, perform video and audio recording and playback, display navigation maps, and run thousands of applications where orienting the cell phone in a specified manner enables a desired use of the device, such as video capture, for example, and convenient acquisition or playback of other types of visual and auditory data. Use of a cell phone in these and other ways in a hands-free manner enables the user to perform other tasks safely and efficiently or, at least, without the need to hold the cell phone. For purposes of the present disclosure, cell phones, tablets, and other similar electronic devices that are sized and shaped to be held in a user's hand or hands, and similarly shaped and sized device with no computing or electronic functionality, will be referred to hereinafter as compact utility devices. It will be understood that the present disclosure, therefore, is directed to stands or holders configured to support a variety of compact utility devices, such as cell phones and tablets, and single application devices, such as book readers, all of which come in a wide array of shapes and sizes.

There is a need for a stand for a compact utility device that is capable of holding devices with various sizes and shaped securely in a desired orientation. Devices and methods according to the disclosure satisfy this need.

### BRIEF SUMMARY OF THE INVENTION

In one aspect, the disclosure describes a stand for a compact utility device includes a base and a holder assembly. The holder assembly includes a housing defining an interior space. The housing is attached to and is supported by the base. A first arm and a second arm are moveably disposed in and extend from the interior space of the housing. The first arm and the second arm extend from opposite sides of the housing and the first arm and the second arm are cooperatively configured to hold a compact utility device. An adjusting mechanism is disposed in the interior space of the housing and is operably connected to the first arm and the second arm and is configured to synchronize movement of the first arm and the second arm when one of the first arm and second arm are moved outwardly or inwardly.

### BRIEF DESCRIPTION OF THE SEVERAL VIEWS OF THE DRAWING(S)

FIG. 1 is a front perspective view of a stand according to the disclosure.

FIG. 2 is a rear perspective view of the stand of FIG. 1.

FIG. 3 is a bottom perspective view of a stand according to the disclosure.

FIG. 4 is a rear perspective view of the stand of FIG. 1 with portions omitted to show internal features of the stand.

FIG. 5 is a front perspective view with portions of the stand omitted to show internal features.

FIG. 6 is a front perspective view with additional portions of the stand omitted to show internal features.

FIG. 7 is a front perspective view with additional portions of the stand omitted to show internal features.

### DETAILED DESCRIPTION OF THE INVENTION

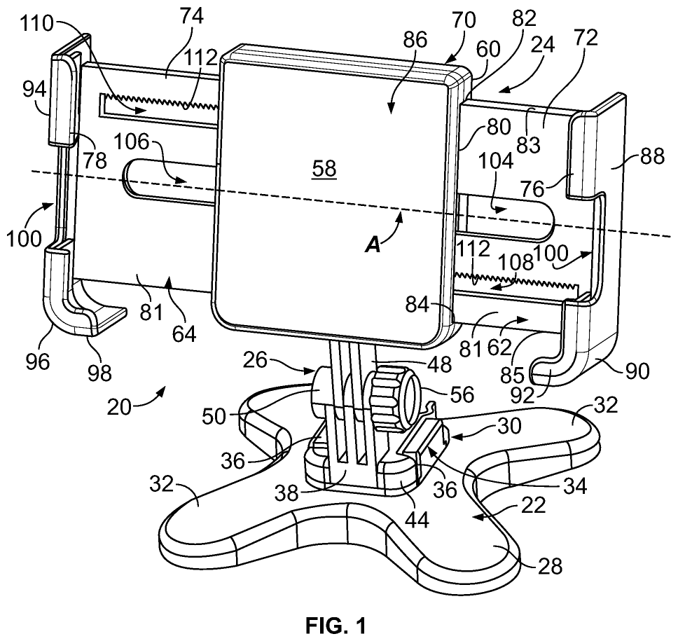

The present disclosure is an adjustable stand or holder for a variety of compact utility devices. In a most general form, and referring to FIG. 1, an embodiment of a stand 20 includes three main portions: a base 22, a holder assembly 24, and an optional adjustable joint 26 disposed between the base and holder mechanism.

The base 22, holder assembly 24, and joint 26 can be made of any suitable material, such as plastic, composite materials, or metal, or combinations thereof. In terms of manufacturing processes, the parts of the stand 20 can be formed by injection molding, additive manufacturing, CNC processes, casting, forging, and any suitable known manufacturing processes.

The base 22 may include a body 28 having a generally flat overall configuration, with any suitable shape, such as circular, rectangular, triangular, or having a central portion 30 with a plurality of feet 32 that extend radially from the central portion to provide stability to the stand 20. In one embodiment, the base 22 includes four feet 32.

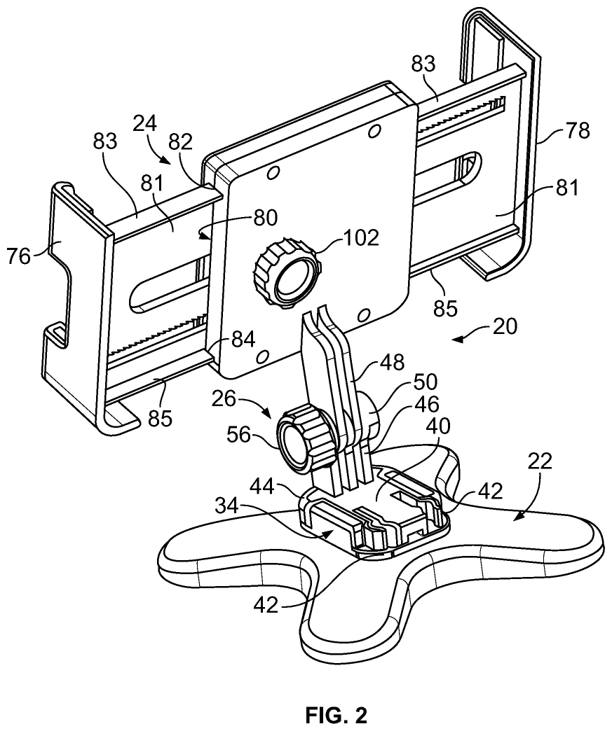

The central portion 30 of the base 22, also referring to FIG. 2, may include an attachment feature or mount, such as a shoe 34 formed on an upper surface thereof. The shoe 34 is shaped and sized to detachably receive a corresponding part of the adjustable joint 26. In one embodiment, the shoe 34 includes a pair of opposed channels 36 that define therebetween a slot sized and shaped to receive a seat 38 formed on the adjustable joint 26. Alternatively, the base 22 can be attached to the holder assembly 24 with a pier (not shown) or any suitable non-adjustable connection, including forming the base and at least one part of the holder assembly as a one-piece construction. The shoe 34 permits detachment of the base 22 from the holder assembly 24 and use of different types of bases (not shown), such as bases provided with magnets or attachable to surfaces via an adhesive, for example.

One embodiment of the seat 38 includes a tongue 40, which may be in the general form of a rectangular tab. The tongue 40 may include a pair of opposed, flanking spring members 42, which may be generally finger-shaped and flexible and spaced apart from the tongue such that the spring members can be pressed inwardly by insertion into the opposed channels 36 of the shoe 34 and the seat 38 can thereby enter into the shoe 34. Once the spring members 42 pass into and through the shoe 34 they resiliently spread outwardly and snap into a position whereby the seat 38 is prevented from disengaging from the shoe 34. Removing the seat 38 from the shoe 34 involves pressing inwardly the spring members 42 to disengage the spring members from the channels 36, which permits the seat to slide back out of the shoe. The seat 38 may be formed with a shoulder or stop 44. The stop 44 is brought into contact with the channels 36 of the shoe 34 when the seat 38 is positioned in a fully engaged condition with the shoe to position the holder assembly 24 on the base 22.

The joint 26 may be in the form of a finger joint, with lower fingers 46 interleaved with upper fingers 48. The lower and upper fingers 46, 48 are able to pivot with respect to each other such that the relative position of the holder assembly 24 relative to the base 22 can be changed. The lower fingers 46 are attached to the seat 38 or formed as a one-piece construction of the seat. The upper fingers 48 are attached to the holding assembly 24 or formed as a one-piece construction of the holder assembly.

The lower fingers 46 may include a fastener housing 50, which is in the form of material of the lower fingers that have a threaded bore or is sized and shaped to house a nut (not shown). A screw fastener 56, which may be a finger screw or a screw with a knob, fashioned to permit manipulation, i.e., tightening and loosening, by a user, passes through the interleaved lower fingers 46 and upper fingers 48 and is engaged with the fastener housing 50 to act as a clamp to fix the angular position of the joint 26 in a desired orientation when clamped and enables the joint to pivot when unclamped. In other words, when the screw fastener 56 is tightened, the lower and upper fingers 46, 48 are clamped to each other and the friction created in the interleaved fingers when so clamped causes the joint 26 to be fixed in the clamped position. The joint 26 permits the holder assembly 24, and therefore a compact device held thereby, to be oriented in a number of positions, such as vertically, horizontally, and angled in-between for convenient viewing and/or use. The joint 26 may be a ball joint or a toothed joint, or any suitable joint that permits the holder assembly to be fixed in a variety of orientations or a fixed pier that orients the holder assembly in a set, predetermined configuration.

Referring to both FIG. 1 and FIG. 2, the holder assembly 24 is attached to the upper fingers 48 of the joint 26, and is supported by the base 22. The holder assembly 24 generally includes a housing 70 with a front cover 58 and a rear cover 60 (referring to the orientation of the features of the holder 20 as presented in the figures). The front and rear covers 58, 60 may be attached by screws or other fasteners to form the housing 70.

In one embodiment, the upper fingers 48 are attached to or part of the rear cover 60. Generally, the front and rear covers 58, 60 enclose an interior space 66. The front cover 58 and rear cover 60 may both be generally rectangular in shape and when fastened together may form a generally rectangular enclosure defining the interior space. The front cover 58 may include an outer layer of material 86 that has a rough or sticky texture, such as an elastomeric coating, and/or may include an imbedded magnet (not shown) to assist in retaining a compact device to the holder 20 when positioned thereon.

The holding assembly 24 includes a first arm 62 that extends into the interior space 66 and extends outwardly to the right (as viewed in the figures) and a second arm 64 that extends into the interior space and extends outwardly to the left, i.e., in the opposite direction relative to the first arm 62. The interior space 66 houses an adjusting mechanism, which will be detailed hereinbelow, which ensures the equal extension and retraction of the arms 62, 64 from the interior space 66 and furthermore enables the clamping of the arms in a desired position. The arms 62, 64 are configured to hold a compact computing device as will be detailed herein and are further configured to interact with the adjusting mechanism to adapt the spacing of the arms to the size and shape of a compact device to be held thereby. In particular, the adaptability of the spacing of the arms 62, 64 afforded by the adjusting mechanism allows devices, such as cell phones, to be held in portrait or landscape orientations as well as a variety of sizes and shapes of such devices.

Each of the arms 62, 64 has a respective back plate 72, 74 and a jaw 76, 78. The back plates 72, 74 both have an I-beam shape with a vertical web 81, an upper flange 83, and a lower flange 85 attached to respective upper and lower edges of the web. The flanges 83, 85 are oriented in a plane normal to the plane of the web 81.

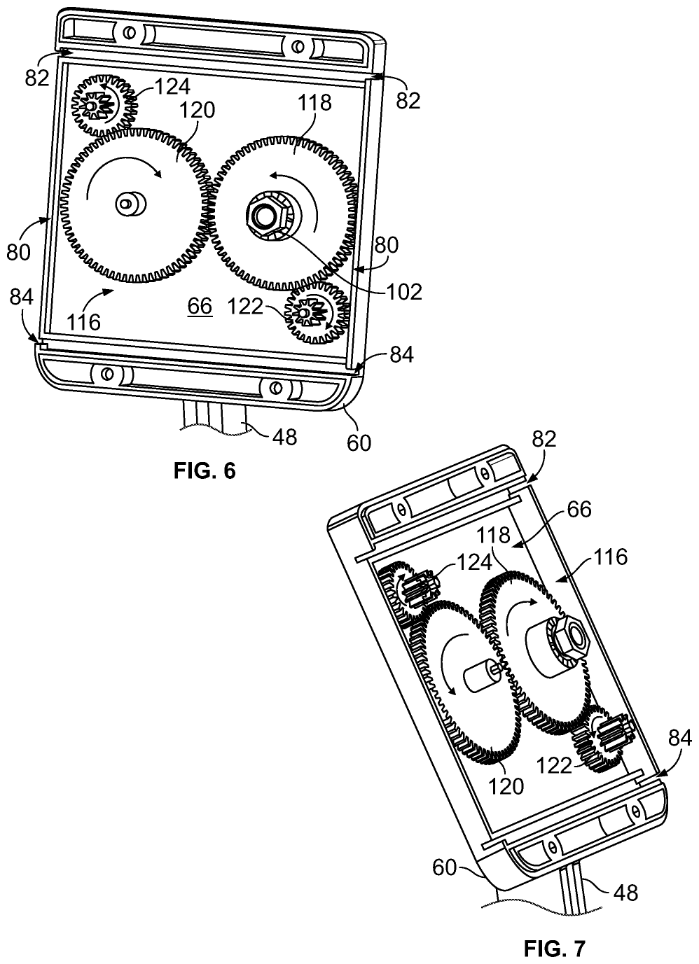

Both the front cover 58 and rear cover 60, or only one of the covers, include a generally vertical notch and a pair of spaced apart notches at respective ends of the vertical notch, which are configured such that when the covers are assembled into housing 70, a vertical slot 80 (FIG. 6 and FIG. 7) is formed on each side, which is sized and shaped to receive the web portion 81 of the back plate 72 of the first arm 62 on the right side of the assembled covers 58, 60 and the web portion 81 of the back plate 74 of the second arm 64 on the left side. The spaced apart notches are formed transverse to the vertical slot 80 to form an upper transverse slot 82 and a lower transverse slot 84 on each side of the housing 70. Both transverse slots 82, 84 are sized and shaped to receive respectively the upper flange 83 and the lower flange 85 of each of the arms 62, 64. The vertical slots 80 and the upper transverse slot 82 and the lower transverse slot 84 guide and brace the arms 62, 64 and help prevent racking or other undesired misalignment of the arms.

The first arm 62 has a first jaw 76 and the second arm 64 has a second jaw 78. The first jaw 76 is “J” shaped (viewed from the front) with a vertical channel 88 transitioning to a curved section 90 and terminating with a horizontal section 92 at a lower end thereof. The second jaw 78 is “L” shaped (viewed from the front) with a vertical channel 94 transitioning to a curved section 96 and terminating with a horizontal section 98 at a lower end thereof. When brought inwardly together to hold a compact device the first and second jaws 76, 78 and the front cover 58 capture and hold the compact device. The jaws 62, 64 are cooperatively configured to hold a compact device because they operate together to secure the device on the stand 20.

Both the first and second jaws 76, 78 have in each respective vertical channel a notch 100, which provides a clearance such that a cable, such as a power cord (not shown), may be connected to the compact device while the device is held by the holder 20. The jaws 76, 78 are movable inwardly, toward the housing 79 and therefore each other, and outwardly. The jaws 76, 78 are fixable in position when adjusted as desired and a clamping knob 102 located on the rear cover 60 (FIG. 2) may be used to fix the jaws in position as will be explained in detail below.

The back plate 72 of the first arm 62 includes a clearance slot 104, which is located about halfway between the upper flange 83 and the lower flange 85. The clearance slot 104 is parallel to arm adjustment axis A. The back plate 74 of the second arm 64 includes a clearance slot 106, which is located about halfway between the upper flange 82 and the lower flange 84. The clearance slot 106 is parallel to arm adjustment axis A and coaxial with the clearance slot 104 of the first arm.

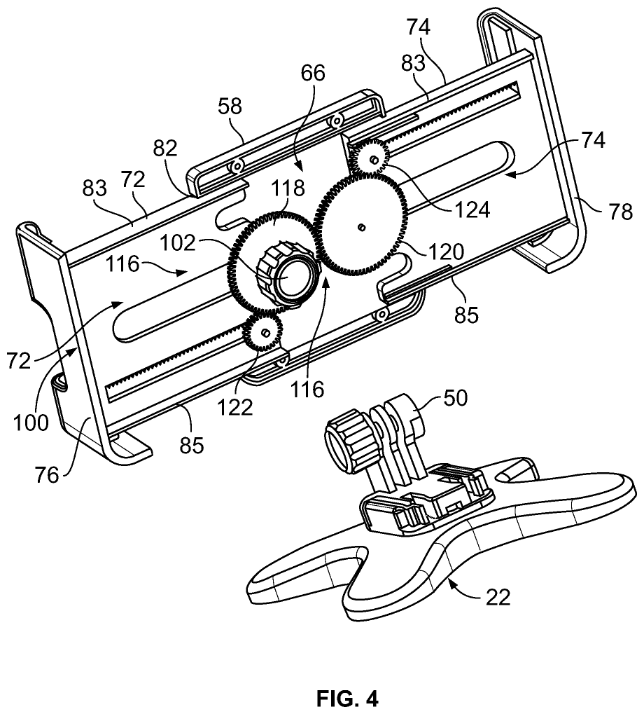

The back plate 72 of the first arm 62 includes a first rack slot 108, which is located on one side of the axis of the clearance slot 104 and between the upper flange 82 and the lower flange 84. For example, rack slot 108 may be “below” the clearance slot 104. The rack slot 108 is parallel to arm adjustment axis A. The back plate 74 of the second arm 64 includes a rack slot 110, which is located on the other side of the clearance slot 106 opposite the axis of the rack slot 108 and between the upper flange 82 and the lower flange 84. For example, the rack slot 110 may be “above” the clearance slot 106. The rack slot 110 is parallel to arm adjustment axis A. Each of the rack slots 108, 110 includes a toothed section 112 in the form of a rack. The toothed sections 112 are configured to engage gear wheels as will explained in connection with FIGS. 4-7.

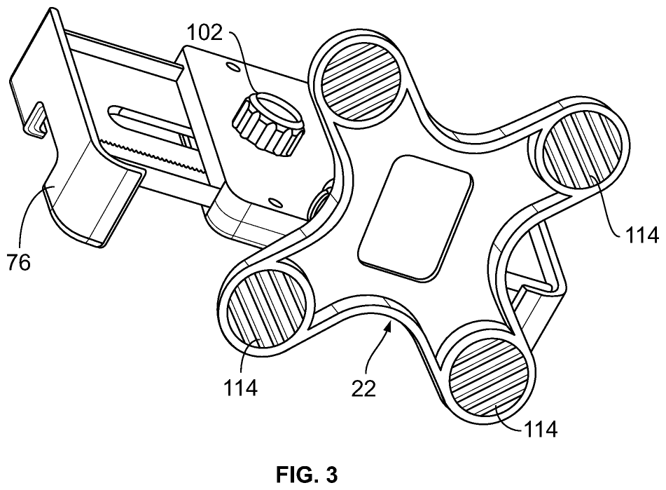

Turning to FIG. 3, the underneath 114 of the base 22, i.e., where the stand 20 contacts a support surface, may be provided with gripping members 114. Gripping members 114 may be elastomeric pads that provide stability to the stand 20, especially on slippery or smooth surfaces where hard plastic, for example, might prove to be unstable. Other gripping members 114 are contemplated, including those having suction cups, magnets, adhesives, and/or fasteners.

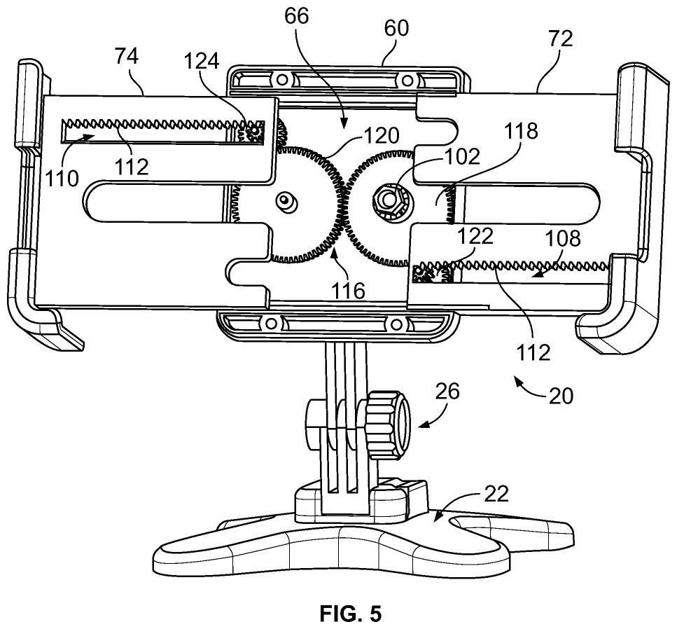

FIGS. 4 and 5 show an embodiment of an adjusting mechanism 116 located in the interior space 66 of the housing 70. FIG. 4 shows the interior space 66 with the rear cover removed and from a rear side view. In particular, the back plates 72, 74 pass between elements of the adjusting mechanism 116 and the front cover 58. FIG. 5 shows the interior space 66 with the front cover removed. Elements of the adjusting mechanism 166 are behind the back plates 72, 74. The illustrated adjusting mechanism 116 provides a geared force transmission connection of the arms 62, 64.

The adjusting mechanism 116 is visible when the rear cover is removed. The adjusting mechanism 116 includes a first driven gear 118 and a second driven gear 120 engaged with the first driven gear. The first driven gear 118 may be mounted such that the clamping knob 102 may be used to clamp the first driven gear and lock the adjusting mechanism in position. The first driven gear 118 and the second driven gear 120 may both be simple spur gears.

The first driven gear 118 is also engaged with a first input gear 122. The first input gear 122 is a double spur gear with a first gear portion engaged with the first driven gear 118 and a second gear portion engaged with the toothed section 112 of the rack slot 108 of the first arm 62. When the first driven gear 118 is turned counterclockwise (viewed from the front) the first input gear 122 is turned clockwise. The engagement of the first input gear 122 with the toothed section 112 of the rack slot 108 of the first arm 62 causes the first arm to move outwardly from the interior space 66 and the housing 70 when the first driven gear 118 is turned counterclockwise.

The second driven gear 120 is engaged with a second input gear 124. The second input gear 124 is also a double spur gear with a first gear portion engaged with the second driven gear 120 and a second gear portion engaged with the toothed section 112 of the rack slot 110 of the second arm 64. When the first driven gear 118 is turned counterclockwise (viewed from the front), the second driven gear 120 is turned clockwise (viewed from the front) and the second input gear 124 is turned counterclockwise. The engagement of the second input gear 124 with the toothed section 112 of the rack slot 110 of the second arm 64 causes the second arm to move outwardly from the interior space 66 and the housing 70 and in an opposite direction relative to the first arm 62.

Because the first driven gear 118 and the second driven gear 120 are engaged respectively with the first and second input gears 122, 124, operation of the adjusting mechanism 116 by moving one of the arms causes the arms 62, 64 to move inwardly or outwardly the same distance in a synchronized manner. In addition, when the arms 62, 64 have been adjusted to hold a device, preventing the adjusting mechanism 116 from operating locks the arms into position. Tightening the clamping knob 102 locks the adjusting mechanism 166 and prevent movement of the gears thereof and thus fixes the arms in position. For purposes of the present disclosure, the term “synchronize,” “synchronization,” and “synchronized” will mean movement of the arms in a coordinated manner, both moving inwardly or outwardly relative to the housing 70, at the same rate involving operation of the adjusting mechanism 116.

Referring to FIG. 6, the counterclockwise rotation of the first driven gear 118 of the adjusting mechanism 116 produces the rotation of the second driven gear 120 in the clockwise direction. The first and second input gears 122, 124 are, in response, rotated clockwise and counterclockwise respectively as shown by the arrows. This rotation of the input gears 122, 124 causes the arms 62, 64 to move synchronously outwardly with the currently depicted position of the toothed sections 112 (FIG. 5). If the position of the toothed sections 112 were to be reversed, the motion of the gearing would reverse when one of the arms were to be pulled outwardly. Pushing one of the arms 62, 64 inwardly would produce the direction of rotation shown in FIG. 7, which is the reverse of that shown in FIG. 6. In this embodiment, it is the movement of one of the arms 62, 64, by a user, that causes the gears to synchronize the movement of the other of the arms. In other words, when one of the arms 62, 64 is moved outwardly, the other of the arms is moved correspondingly outwardly the same amount. One of the advantages of the synchronous amount of movement of the arms afforded by the adjusting mechanism 116 of the disclosure is that the center of gravity of any device held by the arms 62, 64 is always maintained over the base 22, which provides the greatest possible stability to the assembly.

Both FIGS. 6 and 7 show the vertical slot 80 formed, in this embodiment, in the rear cover 60 into which the back plates 72, 74 are insertable (see FIG. 5). Also, the upper and lower transverse slots 82, 84 are shown into which the upper flange and lower flange 83, 85 are insertable (see FIG. 4). It will be understood that the adjusting mechanism 116 disclosed herein is one specific example that provides a synchronous movement of two opposed arms 62, 64 and is further fixable in a selected state to hold securely an associated compact device by the arms. There is contemplated other alternative arrangements of gearing and the like to accomplish the same effect, such that disclosure is not limited by the present example.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention. Terms referring to positions or orientations are given according to the drawing views unless noted otherwise. The term “configured” refers to size and shape of an element or elements unless noted otherwise.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

I/We claim:

1. A stand for a compact utility device, comprising:
a base; and
a holder assembly comprising:
a housing defining an interior space, the housing attached to and supported by the base;
a first arm moveably disposed in and extending from the interior space of the housing;
a second arm moveably disposed in and extending from the interior space of the housing;
wherein the first arm and the second arm extend from opposite sides of the housing and wherein the first arm and the second arm are cooperatively configured to hold a compact utility device; and
an adjusting mechanism disposed in the interior space of the housing, the adjusting mechanism operably connected to the first arm and the second arm and configured to synchronize movement of the first arm and the second arm when one of the first arm and second arm are moved outwardly or inwardly.

2. The stand of claim 1, wherein the adjusting mechanism includes a geared force transmission connection of the first arm with the second arm.

3. The stand of claim 1, wherein the first arm and second arm each includes a web portion at least partially disposed within the housing, each web portion including a toothed section operatively connected to the adjusting mechanism.

4. The stand of claim 3, wherein the adjusting mechanism includes a first input gear engaged with the toothed section of the first arm and a second input gear engaged with the toothed section of the second arm.

5. The stand of claim 4, wherein the first input gear is operatively connected to the second input gear.

6. The stand of claim 5, wherein the adjusting mechanism further comprises a first driven gear engaged with the first input gear and a second driven gear engaged with the second input gear.

7. The stand of claim 6, wherein the first driven gear is directly engaged with the second driven gear to transmit rotation of one of the first input gear and the second input gear to the other of the first input gear and the second input gear.

8. The stand of claim 7, wherein the first input gear and the second input gear are double spur gears, a first gear portion of the first input gear engaged with the first driven gear, a first gear portion of the second input gear engaged with the second driven gear, a second gear portion of the first input gear engaged with the toothed section of the first arm, and a second gear portion of the second input gear engaged with the toothed second of the second arm.

9. The stand of claim 3, wherein each web portion further includes an upper flange and a lower flange opposite the upper flange, both the upper flange and the lower flange oriented transverse to the web portion.

10. The stand of claim 3, wherein the housing comprising a notch sized and shaped on each side thereof, a first notch configured to slidingly receive the web portion of the first arm on a first side of the housing and a second notch configured to slidingly receive the web portion of the second arm on a second side of the housing opposite the first side.

11. The stand of claim 10, wherein the housing comprises a pair of slots each at the first notch and the second notch, each pair of slots configured to guidingly receive the upper flange and the lower flange of one of the first arm or the second arm.

12. The stand of claim 1, further comprising an adjustable joint disposed between and attached to the base and the housing.

13. The stand of claim 12, wherein the joint is configured to be fixed in position.

14. The stand of claim 12, wherein the joint includes a plurality of lower fingers connected to the base and upper fingers connected to the housing, the lower and upper fingers being interleaved and adjustable angularly relative to each other.

15. The stand of claim 1, wherein the base includes a shoe formed on a central portion thereof, the shoe comprising a pair of opposed channels, wherein the lower fingers comprise a seat configured to be releasably secured to the shoe by engaging the seat in the opposed channels of the shoe.

16. The stand of claim 15, wherein the seat includes a rectangular tongue and spring members disposed on opposite sides of the tongue, the spring members configured to be depressed when the seat is inserted into the pair of opposed channels and released into a locking position when the seat is fully inserted.

17. The stand of claim 1, further comprising a clamping mechanism configured to fix the first arm and the second arm in a selected position.

18. The stand of claim 17, wherein the clamping mechanism includes a fastener configured to clamp the adjusting mechanism to prevent operation of the adjusting mechanism.

19. The stand of claim 18, wherein the adjusting mechanism includes a geared transmission operatively synchronizing movement of the first arm and the second arm.

20. The stand of claim 19, wherein the clamping mechanism prevents rotation of the geared transmission.
